(19) United States
(12) Patent Application Publication
(10) Pub. No.: US 2012/0320152 A1
(43) Pub. Date: Dec. 20, 2012

(54) STEREOSCOPIC IMAGE GENERATION APPARATUS AND METHOD

(75) Inventor: Bo Ra Seok, Seoul (KR)

(73) Assignee: Sang Won LEE, Incheon (KR)

(21) Appl. No.: 13/575,029

(22) PCT Filed: Mar. 11, 2011
(86) PCT No.: PCT/KR2011/001700

§ 371 Date: Jul. 25, 2012

(30) Foreign Application Priority Data
Mar. 12, 2010 (KR) 10-2010-0022085

(51) Int. Cl. H04N 13/00

(52) U.S. Cl. 348/42; 348/E13.001

(57) ABSTRACT

A stereoscopic image generation method and apparatus is provided. A single image is segmented into segments, and feature points are extracted from the segments. An object is recognized by using the extracted feature points, and a depth value is assigned to the recognized object. Matching points are acquired according to the depth value. A left image or a right image is reconstructed with respect to the image by using the feature points and the matching points.

### CROSS-REFERENCE(S) TO RELATED APPLICATION

This application is the national phase application of International Application No. PCT/KR2011/001700, filed on Mar. 11, 2011, which claims the benefit of Korean Patent Application No. 10-2010-0022085, filed on Mar. 12, 2010, the contents of which are hereby incorporated by reference in its entirety.

### BACKGROUND

1. Technical Field

The present invention relates to a stereoscopic image generation apparatus and method, and more particularly, to an apparatus and method for generating an image or 3D image of a desired camera position and angle by applying a depth map to a 2D image.

2. Description of the Related Art

3D image display devices capable of displaying images stereoscopically have been developed. A stereoscopic image is realized by the principle of stereo vision through two eyes of a human. Binocular parallax caused by the distance of about 65 mm between two eyes of a human may serve as an important factor to perceive a 3D effect. Therefore, stereo images are required for creating a stereoscopic image. A 3D effect may be expressed in a way that the same image as an actual image appearing to the human eyes is shown to two eyes of the human. For this purpose, two same cameras separated by the distance between two eyes of a human capture an image. An image captured by a left camera is shown to only a left eye, and an image captured by a right camera is shown to only a right eye. However, most general images are images captured by a single camera. Therefore, it is necessary to recreate these images to stereoscopic images.

There is a need for a method for generating a 3D image from a 2D image.

### SUMMARY

An aspect of the present invention is directed to provide a method and apparatus for displaying a stereoscopic image by using an image captured by a single camera, and to provide a method and apparatus for generating a depth map and generating an image of a camera position and angle a user wants by using the depth map.

According to an embodiment of the present invention, a stereoscopic image generation method includes: segmenting a single image into segments; extracting feature points from the segments; recognizing an object using the extracted feature points; assigning a depth value to the recognized object; acquiring matching points according to the depth value; and reconstructing a left image or a right image with respect to the image by using the feature points and the matching points.

The recognizing of the object may include: specifying a plane by connecting the feature points in the segments; comparing RGB levels of adjacent planes in the segments; and recognizing the object according to the comparison result.

The reconstructing of the image may include: acquiring homography, which is 2D geometric information, by using the feature points and the matching points; and reconstructing a left image or a right image with respect to the image by using the acquired homography.

The reconstructing of the image may include: acquiring a camera matrix, which is 3D geometric information, by using the feature points and the matching points; and reconstructing a left image or a right image with respect to the image by using the acquired camera matrix.

General image contents that are not created as stereoscopic images may be utilized as stereo images or 3D images. Therefore, a content provider can reduce production costs by using the existing general images.

### BRIEF DESCRIPTION OF THE DRAWINGS

FIG. 1 is a flow chart illustrating a stereoscopic image generation method according to an embodiment of the present invention.

FIGS. 2a and 2b are diagrams illustrating an example of a method for recognizing an object according to an embodiment of the present invention.

FIG. 3 is a diagram illustrating an example of a depth value assigned to each object according to an embodiment of the present invention.

FIG. 4 is a diagram illustrating an example of a stereoscopic image generation method using 2D geometric information according to an embodiment of the present invention.

FIG. 5 is a diagram illustrating an example of a stereoscopic image generation method using 3D geometric information according to an embodiment of the present invention.

FIGS. 6a through 6e are diagrams illustrating an example of a 3D auto focusing method according to an embodiment of the present invention.

FIG. 7 is a block diagram illustrating a stereoscopic image generation apparatus according to an embodiment of the present invention.

### DETAILED DESCRIPTION

Exemplary embodiments of the present invention will be described below with reference to the accompanying drawings.

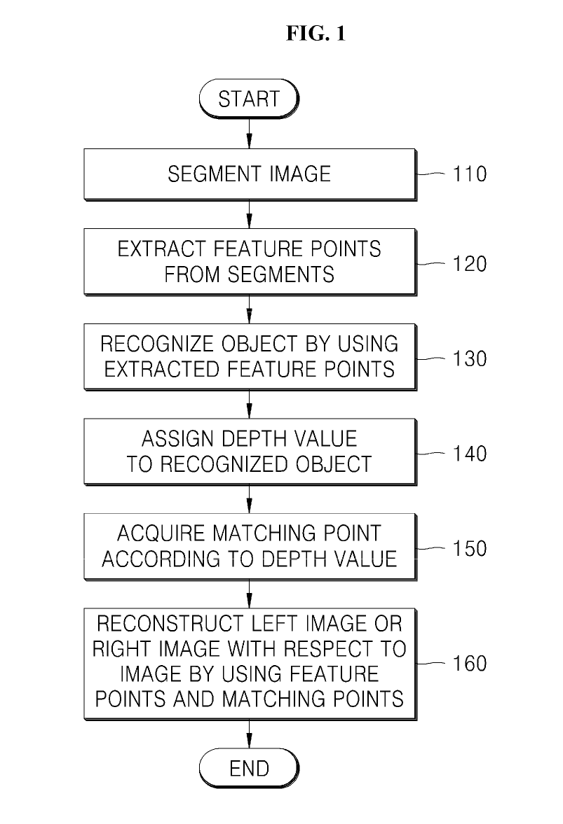

FIG. 1 is a flow chart illustrating a stereoscopic image generation method according to an embodiment of the present invention.

Referring to FIG. 1, a stereoscopic image generation apparatus segments a single image received from the exterior in step 110. Segmentation refers to a process of partitioning a digital image into multiple segments (sets of pixels). The goal of segmentation is to simplify and/or change the representation of an image into something that is more meaningful and easier to analyze. Segmentation is typically used to find positions of objects and boundaries (lines, curves, or the like) within an image. More strictly speaking, segmentation is a process of assigning a label to every pixel within an image such that pixels having the same label share specific visual characteristics. The result of segmentation is a set of segments that collectively cover the entire image, or a set of boundary lines extracted from the image (edge detection). Also, in general, the pixels within the same region are similar to each other with respect to some characteristic or computed property, such as color, intensity, or texture. Adjacent regions may be significantly different with respect to the above characteristics.

In step 120, the stereoscopic image generation apparatus extracts feature points from segments acquired through the segmentation. There is no limitation to the number of the feature points.

In step 130, the stereoscopic image generation apparatus recognizes an object by using the extracted feature points. A plane is specified by connecting the feature points in one extracted segment. That is, a plane is formed by connecting at least three or more feature points. When the plane is not formed by connecting the feature points of the segments, it is determined as an edge. In an embodiment of the present invention, a triangle is formed by connecting the minimal feature points capable of forming the plane, that is, three feature points. Thereafter, red green blue (RGB) levels of adjacent triangles are mutually compared. The adjacent triangles may be combined according to the comparison of the RGB levels and considered as a single plane. Specifically, the maximum value among the RGB levels in one triangle is selected and compared with one value among the RGB levels corresponding to one value selected among the RGB levels in another triangle. When the two values are similar, it is determined as a single plane. That is, if a result obtained by subtracting a lower value from a high value in the two values is less than a predetermined threshold value, the adjacent triangles are combined and considered as a single plane. If greater than the threshold value, the adjacent triangles are recognized as different objects.

Max(R₁,G₁,B₁)−(R₂,G₂,B₂)<Threshold [Mathematical Formula 1]

Referring to Mathematical Formula 1, the maximum value is extracted from the RGB level values of a first triangle. For example, when R₁, G₁ and B₁ level values are 155, 50, and 1, respectively, the R₁ level value is extracted. An R₂ value corresponding to R₁ is extracted from level values of a second triangle. When a value obtained by subtracting the R₂ value from the R₁ value is less than the predetermined threshold value, that is, when a difference between the two level values is small, the two triangles are recognized as a single plane. The threshold value may be arbitrarily determined by a manufacturer. Thereafter, when there is a triangle adjacent to the plane recognized as the single plane, the above procedures are repeated. When it is not recognized as the combined plane any more, the single combined plane is recognized as a single object.

When it is determined as an edge, it is not recognized as an object. Also, in the case of an edge recognized inside the formed plane, it is not recognized as an object. For example, when planes are overlapped, a boundary line of a certain plane is inserted into another plane. In this case, the inserted boundary line of the plane is recognized as an edge and is not recognized as an object.

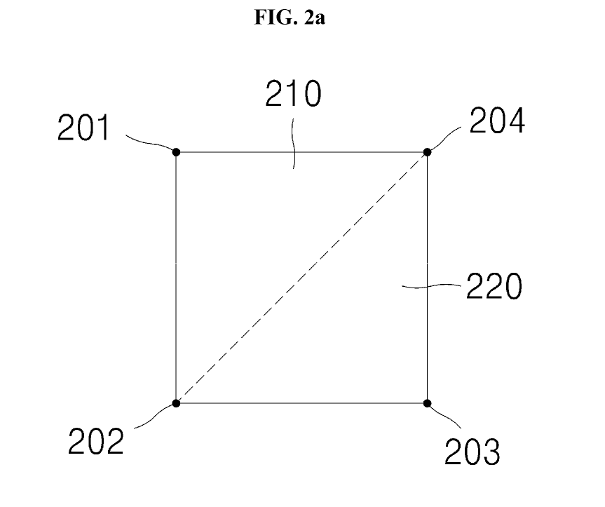

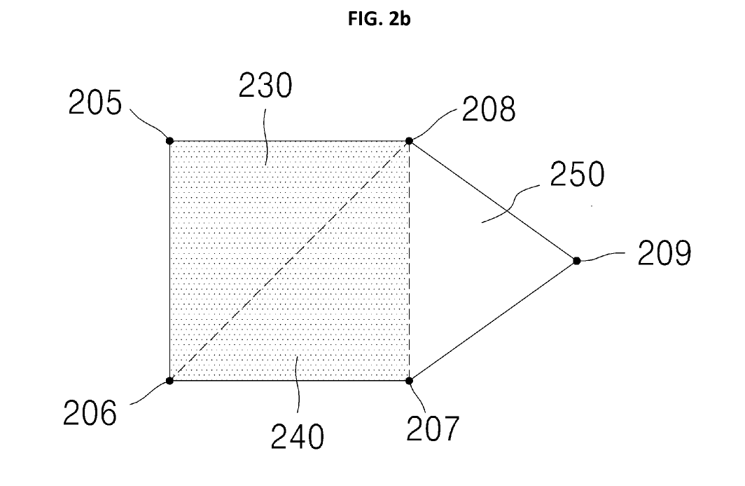

FIGS. 2a and 2b are diagrams illustrating an example of a method for recognizing an object according to an embodiment of the present invention.

FIG. 2a illustrates segments that are segmented in a rectangular image. Feature points 201 to 204 are extracted from the segments. A triangle 210 formed by the feature points 201 to 203 and a triangle 220 formed by the feature points 202 to 204 are specified. RGB levels of the left triangle 210 are detected, and the maximum value is extracted from the detected RGB levels. For example, when the R level is highest, the R level of the right triangle 220 is detected and compared with the R level of the left triangle 210. When a difference between the two values is compared and is less than a predetermined threshold value, the two triangles are specified as a single plane. Therefore, the rectangle defined by combining the two triangles is recognized as an object.

FIG. 2b illustrates segments that are segmented in a pentagonal image. Feature points 205 to 209 are extracted from the segments. A triangle 230 formed by the feature points 205, 206 and 208, a triangle 240 formed by the feature points 206 to 208, and a triangle 250 formed by the feature points 207 to 209 are specified. RGB levels of the left triangle 230 are detected, and the maximum value is extracted from the detected RGB levels. For example, when the R level is highest, the R level of the middle triangle 240 is detected and compared with the R level of the left triangle 230. When a difference between the two values is compared and is less than a predetermined threshold value, the two triangles are specified as a single plane. Thereafter, the RGB levels of the specified rectangle are compared with the RGB levels of the right triangle 250 located adjacent to the specified rectangle. When detecting the RGB levels of the rectangles, in the above example, the R levels are highest and the R levels of the two triangles 230 and 240 may be different. In this case, how to determine the RGB level values of the rectangle may be set by a manufacturer. The RGB levels of any one of the triangles may be a reference, or an average of the RGB levels of the two triangles may be a reference. The RGB levels of the rectangle are compared with the RGB levels of the right triangle 250. When a comparison value is less than a predetermined threshold value, a pentagon formed by combining the rectangle and the triangle is recognized as an object. On the other hand, when equal to or greater than the threshold value, only the rectangle is recognized as an object.

In step 140, the stereoscopic image generation apparatus assigns a depth value to the recognized object. The stereoscopic image generation apparatus generates a depth map by using the recognized object. The depth value is assigned to the recognized object in accordance with a predetermined criterion. In an embodiment of the present invention, as an object is located at a lower position in an image, a greater depth value is assigned thereto.

Typically, in order to generate a 3D effect in a 2D image, an image from different virtual view points should be rendered. In this case, the depth map generates an image of different virtual view points so as to give a depth effect to a viewer, and is used to render an original image.

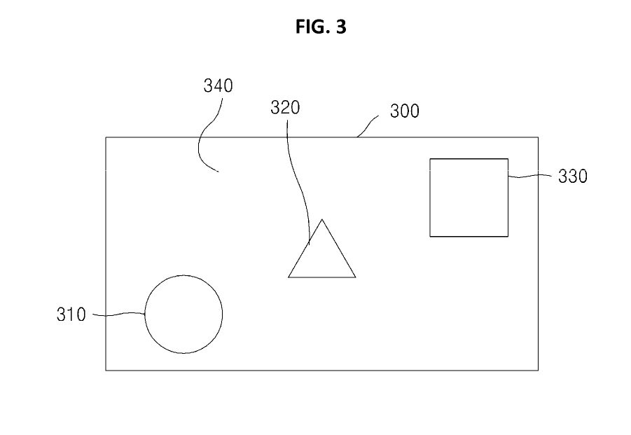

FIG. 3 is a diagram illustrating an example of a depth value assigned to each object according to an embodiment of the present invention.

Referring to FIG. 3, three objects 310, 320 and 330 are illustrated. According to an embodiment of the present invention, the greatest depth value is assigned to the lowest object 310 of the image 300, and a depth value less than the depth value assigned to the lowest object 310 is assigned to the middle object 320. A depth value less than the depth value assigned to the middle object 320 is assigned to the highest object 330. Also, a depth value is also assigned to a background 340. The least depth value is assigned to the background 340. For example, the depth value may be in a range of 0 to 255. 255, 170, 85, and 0 may be assigned to the lowest object 310, the middle object 320, the highest object 330, and the background 340, respectively. The depth values may also be previously set by a manufacturer.

In step 150, the stereoscopic image generation apparatus acquires matching points by using the feature points of the objects according to the depth values assigned to the objects.

The matching points refer to points that are moved according to the depth values assigned to the respective objects. For example, assuming that the coordinates of the feature point of a certain object is (120, 50) and the depth value thereof is 50, the coordinates of the matching point are (170, 50). There is no change in y-coordinates corresponding to the height of the object.

In step 160, in order to generate the stereoscopic image, the stereoscopic image generation apparatus reconstructs a relatively moved image (for example, a right-eye image) from an original image (for example, a left-eye image) by using the feature points and the matching points.

A stereoscopic image generation method according to a first embodiment will be described below. The stereoscopic image generation method according to the first embodiment uses 2D geometric information.

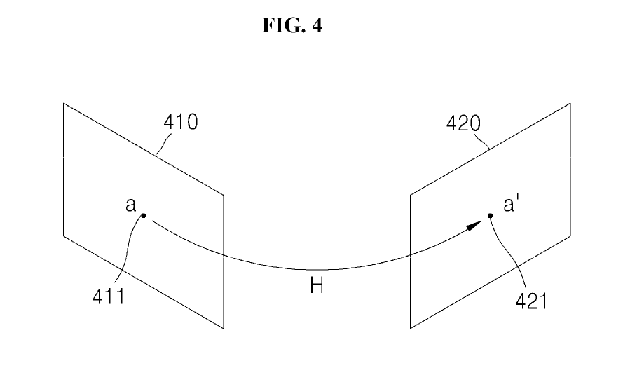

FIG. 4 is a diagram illustrating an example of a stereoscopic image generation method using 2D geometric information.

Referring to FIG. 4, a relationship between a feature point a 411 of an original image 410 and a matching point a′ 421 corresponding to the feature point a is expressed as Mathematical Formulas 2 and 3 below.

$$\begin{matrix}{x}^{′} = {H}_{π} x & [ Mathematical Formula 2 ] \\ ( \begin{matrix}{x}^{′} \\ {y}^{′} \\ 1\end{matrix} ) = ( \begin{matrix}h 11 & h 12 & h 13 \\ h 21 & h 22 & h 23 \\ h 31 & h 32 & 1\end{matrix} ) ( \begin{matrix}x \\ y \\ 1\end{matrix} ) & [ Mathematical Formula 3 ]\end{matrix}$$

x′: 3×1 matrix

x′, y′: x-coordinate and y-coordinate of the matching point a′

x, y: x-coordinate and y-coordinate of the feature point a H_{π}: 3×3 matrix homography

Referring to Mathematical Formula 2 or 3, when coordinates of the feature points or the matching points are eight or more, H_{π} is obtained. After obtaining H_{π}, a left image or a right image, which is a stereoscopic image, can be generated by substituting H_{π} into all pixel values of the original image.

A stereoscopic image generation method according to a second embodiment will be described below. The stereoscopic image generation method according to the second embodiment uses 3D geometric information. A camera matrix is extracted by using feature points and matching points, and a left image or a right image, which is a stereoscopic image, can be generated by using the extracted camera matrix.

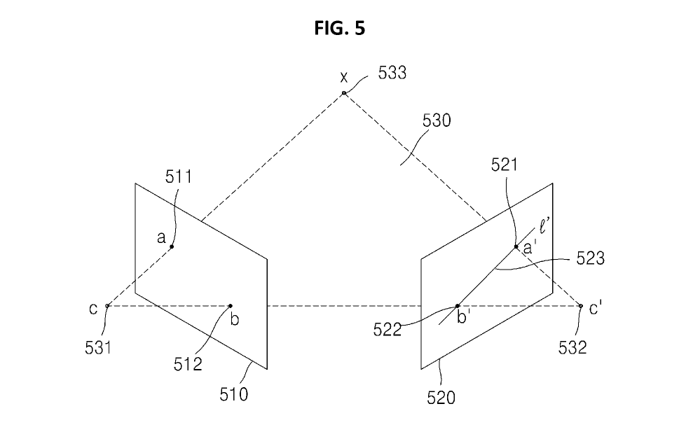

FIG. 5 is a diagram illustrating an example of a stereoscopic image generation method using 3D geometric information.

Referring to FIG. 5, the camera origin C 531 with respect to a feature point a 511 existing in an original image 510, the camera origin C′ 532 with respect to a matching point a′ 521 of the feature point a 511, and point X 533 constitute an epipolar plane. The point X 533 is a point of a 3D space which is met by performing a back projection on the feature point a 511 and the matching point a′ 521 with reference to the camera origin C 531 and the camera origin C′ 532. An epipole b′ 522 of a virtual image 520 corresponding to the matching point represents a crossing point in the virtual image 520 corresponding to the matching points of the camera origin C 531 and the camera origin C′ 532. A line e′ 523 passing through the matching point a′ 521 and the epipole b′ 522 is obtained by an epipolar geometry relationship, as expressed in Mathematical Formula 4 below.

l′=e′×x′=[e′]ₓH_{π}x=Fx[Mathematical Formula 4]

x: 3×1 matrix for coordinates of the feature point a 511

x′: 3×1 matrix for coordinates of the matching point a′ 521

e′: 3×1 matrix for coordinates of the epipole point b′ 522

×: a curl operator

F: 3×3 epipolar fundamental matrix

In Mathematical Formula 4 above, since a′ 521 exists on the line l′ 523, Mathematical Formulas 5 and 6 below are established.

x′^{T}Fx=0 [Mathematical Formula 5]

F^{T}e′=0 [Mathematical Formula 6]

In Mathematical Formula 5, since matrixes for x′ and x are given, F can be calculated. Using F calculated in Mathematical Formula 5, e′ can be calculated from Mathematical Formula 6.

Using e′ calculated in Mathematical Formula 6, a camera matrix P′ for a′ 521 can be calculated from Mathematical Formula 7 below.

P′=[[e′]ₓF|e′] [Mathematical Formula 7]

After calculating P′, a left image or a right image, which is a stereoscopic image, can be generated by substituting P′ into all pixel values of the original image.

In addition, P′ can be calculated in other methods.

Generally, the camera matrix P is expressed as Mathematical Formula 8 below.

$$[ Mathematical Formula 8 ] \\ P = ( \begin{matrix}{f}_{x} & s & {x}_{0} \\ 0 & {f}_{y} & {y}_{0} \\ 0 & 0 & 1\end{matrix} ) ( \begin{matrix}1 & 0 & 0 & 0 \\ 0 & 1 & 0 & 0 \\ 0 & 0 & 1 & 0\end{matrix} ) ( \begin{matrix}{R}_{3 \times 3} & t \\ 0 & 1\end{matrix} ) \qquad$$

In Mathematical Formula 8, a left matrix represents a matrix for camera's internal intrinsic values, and a middle matrix represents a projection matrix. fₓ and f_{y} represent scale factors, and s represents a skew. x₀ and y₀ represent principal points, and R₃×₃ represents a rotation matrix. t represents a real space coordinate value.

R₃×₃ is expressed as Mathematical Formula 9 below.

$$[ Mathematical Formula 9 ] \\ {R}_{3 \times 3} = ( \begin{matrix}1 & 0 & 0 \\ 0 & cos φ & - sin φ \\ 0 & sin φ & cos φ\end{matrix} ) ( \begin{matrix}cos θ & 0 & sin φ \\ 0 & 1 & 0 \\ - sin θ & 0 & cos θ\end{matrix} ) ( \begin{matrix}cos γ & - sin γ & 0 \\ sin γ & cos γ & 0 \\ 0 & 0 & 1\end{matrix} ) \qquad$$

In an embodiment of the present invention, the camera matrix of the original image 510 may be assumed as Mathematical Formula 10 below.

$$P = ( I \vert 0 ) = ( \begin{matrix}1 & 0 & 0 & 0 \\ 0 & 1 & 0 & 0 \\ 0 & 0 & 1 & 0\end{matrix} ) \qquad [ Mathematical Formula 10 ]$$

Also, Mathematical Formula 11 below is established.

Px=P′x′ [Mathematical Formula 11]

Since P, x and x′ are already given, P′ may be obtained from Mathematical Formula 11. Therefore, after obtaining P′, a left image or a right image, which is a stereoscopic image, can be generated by substituting P′ into all pixel values of the original image.

In addition, the stereoscopic image generation apparatus generates an occlusion region by using adjacent values. The occlusion region represents a region that has no value in an image generated upon the stereoscopic image generation.

As another embodiment of the present invention, an embodiment of a 3D auto focusing will be described. Since camera focuses between a left image and a right image upon the stereoscopic image generation are not identical, a user may feel very dizzy when viewing the stereoscopic image, or may view a distorted image.

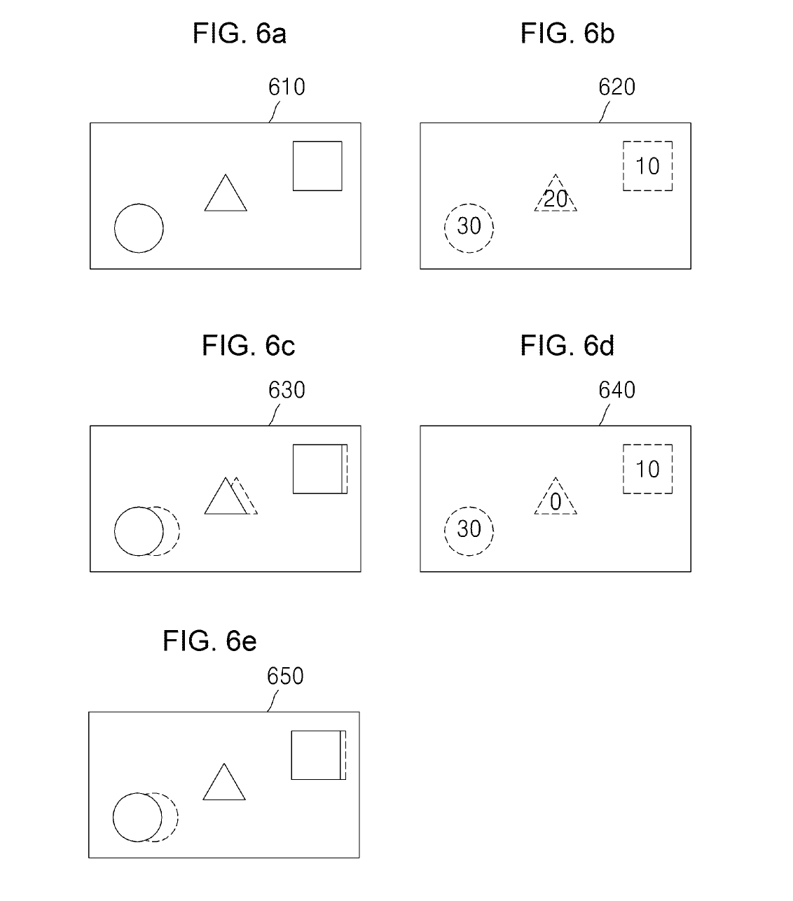

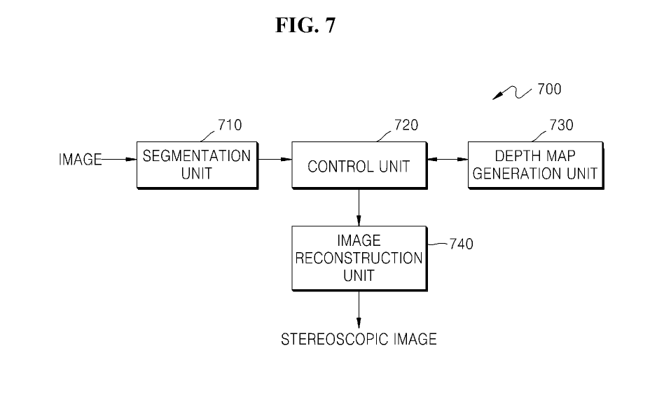

FIGS. 6a through 6e are diagrams illustrating an example of a 3D auto focusing method according to an embodiment of the present invention.

FIG. 6a illustrates an original image 610, and FIG. 6b illustrates other image 620 corresponding to the original image 610 in a pair of stereoscopic images. Depth values are assigned to the respective objects of FIG. 6b. Numbers written in the respective objects of FIG. 6b represent the depth values. FIG. 6c illustrates a virtual image 630 in which the original image 610 viewed by the viewer is combined with other image 620 corresponding to the original image 610 in the pair of stereoscopic images. Focuses of human eyes are changed depending on which one of the objects the viewer views. When the focuses are not identical, the viewer feels very dizzy. Therefore, in an embodiment of the present invention, the focus is adjusted to any one of the objects. In FIG. 6d, the focus is adjusted to the middle object by setting the depth value of the middle object (triangle) to zero in the image illustrated in FIG. 6b. In this case, a viewer cannot feel a 3D effect with respect to the object focused like in FIG. 6e, and the focus is adjusted to this object. As an auto focusing method, a depth value is set to zero with respect to an object to be focused among a pair of stereoscopic images that are already generated. Alternatively, in order to create 3D from 2D, a depth value is set to zero with respect to an object to be focused upon generation of an image corresponding to an original image. Alternatively, when vertical axes of left and right images are different, a 3D auto focusing is performed by extracting matching points from left and right images and removing a vertical axis error. In regard to an edge window size, a 3D auto focusing is performed by calculating edge values of a vertical axis and a horizontal axis by using a sobel operator and determining feature points by using an edge orientation. Also, in order to generate a stereoscopic image, two cameras may be used to capture an image after previously focusing on one object or subject.

FIG. 7 is a diagram illustrating a stereoscopic image generation apparatus according to an embodiment of the present invention.

Referring to FIG. 7, the stereoscopic image generation apparatus 700 includes a segmentation unit 710, a control unit 720, a depth map generation unit 730, and an image reconstruction unit 740.

The segmentation unit 710 segments a single image received from the exterior.

The control unit 720 extracts feature points of segments acquired through the segmentation. There is no limitation to the number of the feature points. Thereafter, the control unit 720 recognizes objects by using the extracted feature points. Specifically, the control unit 720 specifies a plane by connecting the feature points in a single extracted segment. That is, the control unit 720 forms a plane by connecting at least three or more feature points. When the plane is not formed by connecting the feature points of the segment, the control unit 720 determines it as an edge. In an embodiment of the present invention, the control unit 720 forms a triangle by connecting the minimal feature points capable of forming the plane, that is, three feature points. Thereafter, the control unit 720 mutually compares RGB levels of adjacent triangles. The adjacent triangles may be combined according to the comparison of the RGB levels and considered as a single plane. Specifically, the control unit 720 selects the maximum value among the RGB levels in one triangle and compares the selected maximum value with one value among the RGB levels corresponding to one value selected among the RGB levels in another triangle. When the two values are similar, the control unit 720 determines it as a single plane. That is, if a result obtained by subtracting a lower value from a high value in the two values is less than a predetermined threshold value, the control unit 720 combines the adjacent triangles and considers them as a single plane. If greater than the threshold value, the control unit 720 recognizes the adjacent triangles as different objects. Also, when it is determined as an edge, the control unit 720 does not recognize it as an object. In addition, in the case of an edge recognized inside the formed plane, the control unit 720 does not recognize it as an object. For example, when the planes are overlapped, a boundary line of a certain plane is inserted into another plane. In this case, the inserted boundary line of the plane is recognized as an edge and is not recognized as an object.

The depth map generation unit 730 assigns a depth value to the recognized object. The depth map generation unit 730 generates a depth map by using the recognized object, and assigns the depth value to the recognized object in accordance with a predetermined criterion. In an embodiment of the present invention, as an object is located at a lower position in an image, a greater depth value is assigned thereto.

The control unit 720 acquires matching points by using the feature points of the objects according to the depth values assigned to the objects. The matching points refer to points that are moved according to the depth values assigned to the respective objects. For example, assuming that the coordinates of the feature point of a certain object is (120, 50) and the depth value thereof is 50, the coordinates of the matching point are (170, 50). There is no change in y-coordinates corresponding to the height of the object.

In order to generate the stereoscopic image, the image reconstruction unit 740 reconstructs a relatively moved image (for example, a right-eye image) from an original image (for example, a left-eye image) by using the feature points and the matching points. As the image reconstruction method, there are a method using 2D geometric information and a method using 3D geometric information.

According to the method using the 2D geometric information, the control unit 720 obtains a 3×3 matrix homography H₇, by using feature points and matching points, and the image reconstruction unit 740 may generate a left image or a right image, which is a stereoscopic image, by substituting H_{π} into all pixel values of the original image. The control unit 720 extracts a camera matrix by using an epipolar geometry relationship, based on the feature points and the matching points. Since this has been described above, a detailed description thereof will be omitted.

According to the method using the 3D geometric information, the control unit 720 extracts a camera matrix by using feature points and matching points, and the image reconstruction unit 740 may generate a left image or a right image, which is a stereoscopic image, by using the extracted camera matrix.

In addition, the image reconstruction unit 740 generates an occlusion region by using adjacent values. The occlusion region represents a region that has no value in an image generated upon the stereoscopic image generation.

As another embodiment, in order to solve a problem that a user may feel very dizzy when viewing the stereoscopic image, or may view a distorted image because camera focuses between a left image and a right image are not identical, the image reconstruction unit 740 adjusts a focus to any one of the objects. That is, the image reconstruction unit 740 removes a depth value of a target object. As an auto focusing method, a depth value is set to zero with respect to an object to be focused among a pair of stereoscopic images that are already generated. Alternatively, in order to create 3D from 2D, a depth value is set to zero with respect to an object to be focused upon generation of an image corresponding to an original image. Also, in order to generate a stereoscopic image, two cameras may be used to capture an image after previously focusing on one object or subject.

The above-described stereoscopic image generation method can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. (Also, functional programs, codes, and code segments for accomplishing the present invention can be easily construed by programmers skilled in the art to which the present invention pertains.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A stereoscopic image generation method, comprising:
segmenting a single image into segments;
extracting feature points from the segments;
recognizing an object using the extracted feature points;
assigning a depth value to the recognized object;
acquiring matching points according to the depth value; and
reconstructing a left image or a right image with respect to the image by using the feature points and the matching points.

2. The stereoscopic image generation method of claim 1, wherein the recognizing of the object comprises:
specifying a plane by connecting the feature points in the segments;
comparing RGB levels of adjacent planes in the segments; and
recognizing the object according to the comparison result.

3. The stereoscopic image generation method of claim 1, wherein the reconstructing of the image comprises:
acquiring homography, which is 2D geometric information, by using the feature points and the matching points; and
reconstructing the left image or the right image with respect to the image by using the acquired homography.

4. The stereoscopic image generation method of claim 1, wherein the reconstructing of the image comprises:
acquiring a camera matrix, which is 3D geometric information, by using the feature points and the matching points; and
reconstructing the left image or the right image with respect to the image by using the acquired camera matrix.

5. The stereoscopic image generation method of claim 2, wherein the recognizing of the object comprises:
selecting a maximum value among the RGB levels in the plane;
comparing the maximum value with one value among the RGB levels in an adjacent plane, said one value among the RGB levels in the adjacent plane corresponding to the maximum value selected among the RGB levels in the plane;
determining a difference between the maximum value and said one value; and
recognizing the plane and the adjacent plane as different objects when the difference is greater than a preset threshold value, and recognizing the plane and the adjacent plane as a single object when the difference is not greater than the preset threshold value.

6. A stereoscopic image generation method, comprising:
segmenting a single image into segments by using a segmentation unit;
extracting feature points from the segments by a control unit;
recognizing an object using the extracted feature points by the control unit;
assigning a depth value to the recognized object by a depth map generation unit;
acquiring matching points according to the depth value by the control unit; and
reconstructing a left image or a right image with respect to the image by using the feature points and the matching points by an image reconstruction unit.

7. The stereoscopic image generation method of claim 6, wherein the recognizing of the object comprises:
specifying a plane by connecting the feature points in the segments;
comparing RGB levels of adjacent planes in the segments; and
recognizing the object according to the comparison result.

8. The stereoscopic image generation method of claim 6, wherein the reconstructing of the image comprises:
acquiring homography, which is 2D geometric information, by using the feature points and the matching points; and
reconstructing the left image or the right image with respect to the image by using the acquired homography.

9. The stereoscopic image generation method of claim 6, wherein the reconstructing of the image comprises:
acquiring a camera matrix, which is 3D geometric information, by using the feature points and the matching points; and
reconstructing the left image or the right image with respect to the image by using the acquired camera matrix.

10. The stereoscopic image generation method of claim 7, wherein the recognizing of the object comprises:
selecting a maximum value among the RGB levels in the plane;
comparing the maximum value with one value among the RGB levels in an adjacent plane, said one value among the RGB levels in the adjacent plane corresponding to the maximum value selected among the RGB levels in the plane;
determining a difference between the maximum value and said one value; and
recognizing the plane and the adjacent plane as different objects when the difference is greater than a preset threshold value, and recognizing the plane and the adjacent plane as a single object when the difference is not greater than the preset threshold value.

11. A stereoscopic image generation apparatus, comprising:
a segmentation unit segmenting a single image into segments;
a control unit that extracts feature points from the segments, recognizes an object using the extracted feature points, and acquires matching points according to a depth value assigned by a depth map generation unit;
the depth map generation unit assigning the depth value to the recognized object; and
an image reconstruction unit reconstructing a left image or a right image with respect to the image by using the feature points and the matching points.

12. The stereoscopic image generation apparatus of claim 11, wherein the control unit specifies a plane by connecting the feature points in the segments, compares RGB levels of adjacent planes in the segments, and recognizes the object according to the comparison result.

13. The stereoscopic image generation apparatus of claim 11, wherein the image reconstruction unit acquires homography, which is 2D geometric information, by using the feature points and the matching points, and reconstructs the left image or the right image with respect to the image by using the acquired homography.

14. The stereoscopic image generation apparatus of claim 11, wherein the image reconstruction unit acquires a camera matrix, which is 3D geometric information, by using the feature points and the matching points, and reconstructs the left image or the right image with respect to the image by using the acquired camera matrix.

15. The stereoscopic image generation apparatus of claim 12, wherein the control unit selects a maximum value among the RGB levels in the plane, compares the maximum value with one value among the RGB levels in an adjacent plane, said one value among the RGB levels in the adjacent plane corresponding to the maximum value selected among the RGB levels in the plane, determines a difference between the maximum value and said one value, and recognizes the plane and the adjacent plane as different objects when the difference is greater than a preset threshold value, and recognizes the plane and the adjacent plane as a single object when the difference is not greater than the preset threshold value.
